(19) United States
(12) Patent Application Publication
(10) Pub. No.: US 2013/0116814 A1
(43) Pub. Date: May 9, 2013

(54) FEEDFORWARD CONTROL ADJUSTED WITH ITERATIVE LEARNING

(71) Applicant: NIKON CORPORATION, Tokyo (JP)

(72) Inventor: Pai-Hsueh Yang, Palo Alto, CA (US)

(73) Assignee: NIKON CORPORATION, Tokyo (JP)

(21) Appl. No.: 13/670,719

(22) Filed: Nov. 7, 2012

Related U.S. Application Data
(60) Provisional application No. 61/556,420, filed on Nov. 7, 2011.

(51) Int. Cl. G06F 19/00

(52) U.S. Cl. 700/121

(57) ABSTRACT

A method for controlling a mover assembly (220C) includes the steps of: (i) providing a control system (224) that includes a feedback control (440), an iterative learning control (442), and a feedforward control (444); (ii) moving a stage (220A) through a first movement with the mover assembly (220C) being controlled with the control system (224); (iii) collecting first movement information relating to the first movement of the stage (220A) with the iterative learning control (442); (iv) adjusting the iterative learning control (442) using the first movement information; (v) repeating steps (ii) through (iv) until the iterative learning control (442) converges for the first movement; and (vi) adjusting the feedforward control (444) using Iterative information from the iterative learning control (442).

### RELATED INVENTION

This application claims priority on U.S. Provisional Application Ser. No. 61/556,420, filed Nov. 7, 2011 and entitled “METHOD FOR ACCURATE FEEDFORWARD CONTROL DESIGN AND ITERATIVE LEARNING CONTROL LEARNING TIME REDUCTION”. As far as permitted, the contents of U.S. Provisional Application Ser. No. 61/556,420 are incorporated herein by reference.

### BACKGROUND

Exposure apparatuses are commonly used to transfer images from a reticle onto a semiconductor wafer during semiconductor processing. A typical exposure apparatus includes an illumination source, a reticle stage assembly that positions a reticle, an optical assembly, a wafer stage assembly that positions a semiconductor wafer, a measurement system, and a control system. The measurement system constantly monitors the position of the reticle and the wafer, and, with information from the measurement system, the control system controls each stage assembly to constantly adjust the position of the reticle and the wafer. The features of the images transferred from the reticle onto the wafer are extremely small. Accordingly, the precise positioning of the wafer and the reticle is critical to the manufacturing of high quality wafers.

### SUMMARY

The present invention is directed to a method for controlling a mover assembly that moves a stage a first movement (e.g. a first trajectory), and also moves the stage a second movement (e.g. a second trajectory) that is different from the first movement. In one embodiment, the method includes the steps of: (i) providing a control system that controls the mover assembly, the control system including a feedforward control, a feedback control, and an iterative learning control (“ILC”); (ii) moving the stage through a first movement with the mover assembly being controlled with the control system; (iii) collecting first movement information relating to the first movement of the stage with the iterative learning control; (iv) adjusting the iterative learning control using the first movement information; (v) repeating steps (ii) through (iv) until the iterative learning control converges for the first movement; and (vi) adjusting the feedforward control using a converged force command from the iterative learning control.

As provided herein, the adjusting of the feedforward control using the converged force command allows for the optimization of the parametric feedforward control. With this design, the problem of a long learning time for the iterative learning control for every subsequent individual movement or portion thereof is solved by an accurate parametric feedforward control that has been optimized with the perfect force information (“converged force command”) provided by the iterative learning control from the previous trajectory. Stated in another fashion, improvement of the co-operating parametric feedforward control may significantly improve the baseline system performance without iterative learning control, and thus reduces the learning time of the iterative learning control for each different trajectory.

As used herein, the converging of the iterative learning control shall have occurred when all the repeatable stage following errors are removed. At this time, the converged force command learned with the iterative learning control is used to adjust the feedforward control.

In one embodiment, the method can include the steps of (a) moving the stage through the first movement with the mover assembly being controlled with the control system utilizing the adjusted feedforward control; (b) collecting first movement information relating to the first movement of the stage with the iterative learning control; (c) adjusting the iterative learning control using the first movement information; and (d) repeating steps (a) through (c) until the iterative learning control converges for the first movement. With the accurate feedforward control, the learning time for the iterative learning control will likely only take a few iterations to converge for the first movement with the adjusted feedforward control.

Further, the method can include the steps of (A) moving the stage through a second movement that is different from the first movement with the mover assembly being controlled with the control system utilizing the adjusted feedforward control; (B) collecting second movement information relating to the second movement of the stage with the iterative learning control; (C) adjusting the iterative learning control for the second movement using the second movement information; and (D) repeating steps (A) through (C) until the iterative learning control converges for the second movement. With the accurate feedforward control, the learning time for the iterative learning control will likely only take a few iterations to converge for the second movement.

Additionally, the method can include the steps of (I) moving the stage through a third movement that is different from the first and second movements with the mover assembly being controlled with the control system utilizing the adjusted feedforward control; (II) collecting third movement information relating to the third movement of the stage with the iterative learning control; (III) adjusting the iterative learning control for the third movement using the third movement information; and (IV) repeating steps (I) through (III) until the iterative learning control for the third movement converges. With the accurate feedforward control, the learning time for the iterative learning control will likely only take a few iterations to converge for the third movement.

It should be noted that this procedure can be repeated for each subsequent, different movement, and the convergence time of the iterative learning control will be reduced for each individual, different movement because of the accuracy of the feedforward control.

In another embodiment, the present invention is directed to a method comprising the steps of: (i) providing a control system that controls the mover assembly, the control system including a feedforward control, a feedback control, and an iterative learning control; (ii) moving the stage through a first movement with the mover assembly being controlled with the control system; (iii) collecting first movement information relating to the first movement of the stage with the iterative learning control; and (iv) adjusting the feedforward control using the converged force command of the iterative learning control.

In still another embodiment, the present invention is directed to an assembly that includes a stage that retains the work piece; a mover assembly that moves the stage and the work piece a first movement; and a control system that controls the mover assembly. In this embodiment, the control system can include a feedforward control, a feedback control, and an iterative learning control. In one embodiment, the feedforward control can be adjusted using Iterative learning control information from the first movement to optimize the parametric feedforward control.

Moreover, the present invention is directed to an exposure apparatus, and a method for transferring an image to a work piece.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of an exposure apparatus having features of the present invention;

FIG. 2 is a simplified top perspective illustration of a stage assembly having features of the present invention and a work piece;

FIG. 3 is a graph that illustrates position versus time for an trajectory of the stage assembly;

FIG. 4 is a simplified schematic of a control system that can be used to control the stage assembly of FIG. 2;

FIG. 5 is a flow chart that illustrates one embodiment of how the operation of a control system is optimized;

FIG. 6A is a graph that illustrates X axis, ILC force and curve fitted, X axis feedforward trajectory versus time for a small portion of the trajectory;

FIG. 6B is a graph that illustrates the fitting error versus time for the X axis ILC force and the curved fitted, X axis feedforward trajectory;

FIG. 7A is a graph that illustrates Y axis, ILC force and curve fitted, Y axis feedforward trajectory versus time for a small portion of the trajectory;

FIG. 7B is a graph that illustrates the fitting error versus time for the Y axis ILC force and the curved fitted, Y axis feedforward trajectory;

FIG. 8A is a graph that illustrates Z axis, ILC force and curve fitted, Z axis feedforward trajectory versus time for a small portion of the trajectory;

FIG. 8B is a graph that illustrates the fitting error versus time for the Z axis ILC force and the curved fitted, Z axis feedforward trajectory;

FIG. 9A is a graph that illustrates theta X, ILC force and curve fitted, theta X feedforward trajectory versus time for a small portion of the trajectory;

FIG. 9B is a graph that illustrates the fitting error versus time for the theta X ILC force and the curved fitted, theta X feedforward trajectory;

FIG. 10A is a graph that illustrates theta Y, ILC force and curve fitted, theta Y feedforward trajectory versus time for a small portion of the trajectory; and

FIG. 10B is a graph that illustrates the fitting error versus time for the theta Y ILC force and the curved fitted, theta Y feedforward trajectory.

### DESCRIPTION

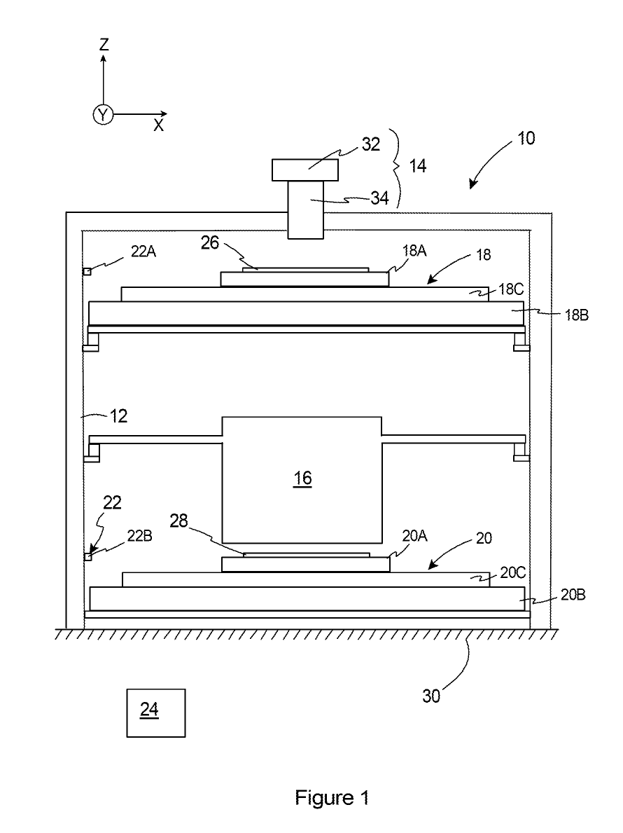

FIG. 1 is a schematic illustration of a precision assembly, namely an exposure apparatus 10 having features of the present invention. The exposure apparatus 10 includes an apparatus frame 12, an illumination system 14 (irradiation apparatus), an optical assembly 16, a reticle stage assembly 18, a wafer stage assembly 20, a measurement system 22, and a control system 24. The design of the components of the exposure apparatus 10 can be varied to suit the design requirements of the exposure apparatus 10. The exposure apparatus 10 is particularly useful as a lithographic device that transfers a pattern (not shown) of an integrated circuit from a reticle 26 onto a semiconductor wafer 28. The exposure apparatus 10 mounts to a mounting base 30, e.g., the ground, a base, or floor or some other supporting structure.

As an overview, in certain embodiments, the control system 24 disclosed herein is uniquely designed to control one or both of the stage assemblies 18, 20 with improved accuracy. More specifically, in certain embodiments, the control system 24 utilizes information from previous movements of the stage to optimize the parametric feedforward control for subsequent movements of the stage. Even more specific, a feedforward control may be optimized using a converged force command learned by an iterative learning control for a first movement. Once the feedforward control is optimized, it will improve the stage accuracy for all arbitrary movements even before those movements are learned by iterative learning control. Thus, afterwards the optimized feedforward control helps to reduce the learning time of the iterative learning control for those movements, and the iterative learning control will converge more quickly for subsequent movements, and the stage is moved to the correct position quicker. As a result thereof, the wafer 28 and/or the reticle 26 can be positioned with improved accuracy, and the stage assemblies 18, 20 can be operated more efficiently. This can result in the manufacturing of higher density wafers 28 with the exposure apparatus 10.

A number of Figures include an orientation system that illustrates an X axis, a Y axis that is orthogonal to the X axis, and the Z axis that is orthogonal to the X and Y axes. It should be noted that any of these axes can also be referred to as the first, second, and/or third axes.

There are a number of different types of lithographic devices. For example, the exposure apparatus 10 can be used as a scanning type photolithography system. Alternatively, the exposure apparatus 10 can be a step-and-repeat type photolithography system. However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head.

The apparatus frame 12 is rigid and supports the components of the exposure apparatus 10. The apparatus frame 12 illustrated in FIG. 1 supports the reticle stage assembly 18, the optical assembly 16, and the illumination system 14 above the mounting base 30.

The illumination system 14 includes an illumination source 32 and an illumination optical assembly 34. The illumination source 32 emits a beam (irradiation) of light energy. The illumination optical assembly 34 guides the beam of light energy from the illumination source 32 to the optical assembly 16. The illumination source 32 can be a g-line source (436 nm), an i-line source (365 nm), a KrF excimer laser (248 nm), an ArF excimer laser (193 nm), a F₂ laser (157 nm), or an EUV source (13.5 nm). Alternatively, the illumination source 32 can generate charged particle beams such as an x-ray or an electron beam.

The optical assembly 16 projects and/or focuses the light leaving the reticle 26 to the wafer 28. Depending upon the design of the exposure apparatus 10, the optical assembly 16 can magnify or reduce the image illuminated on the reticle 26.

The reticle stage assembly 18 holds and positions the reticle 26 relative to the optical assembly 16 and the wafer 28. In FIG. 1, the reticle stage assembly 18 includes a reticle stage 18A that retains the reticle 26, a reticle stage base 18B, and a reticle stage mover assembly 18C that positions the reticle stage 18A and the reticle 26. The reticle stage mover assembly 18B can be designed to move the reticle 26 with six degrees of freedom (X, Y, and Z axes, and about X, Y, and Z axes) relative to the reticle stage base 18B. In alternate embodiments, the reticle stage mover assembly 18B can be designed to move the reticle 26 with one (Y axis) or three (X and Y axes, and about Z axis) degrees of freedom.

Somewhat similarly, the wafer stage assembly 20 holds and positions the wafer 28 with respect to the projected image of the illuminated portions of the reticle 26. In FIG. 1, the wafer stage assembly 20 includes a wafer stage 20A that retains the wafer 28, a wafer stage base 20B, and a wafer stage mover assembly 20C that positions the wafer stage 20A and the wafer 28. The wafer stage mover assembly 20C can be designed to move the wafer 28 with up to six degrees of freedom (along the X, Y, and Z axes, and about X, Y, and Z axes) relative to the wafer stage base 20B.

The measurement system 22 monitors movement of the reticle 26 and the wafer 28 relative to the optical assembly 16 or some other reference. With this information, the apparatus control system 24 can control the reticle stage assembly 18 to precisely position the reticle 26 and the wafer stage assembly 20 to precisely position the wafer 28. For example, the measurement system 22 can utilize multiple laser interferometers, encoders, autofocus systems, and/or other measuring devices. In FIG. 1, the measurement system 22 includes (i) a reticle measurement system 22A (illustrated as a box) that monitors the position of the reticle stage 18B and the reticle 26, and (ii) a wafer measurement system 22B (illustrated as a box) that monitors the position of the wafer stage 20A.

The control system 24 is connected to the reticle stage assembly 18, the wafer stage assembly 20, and the measurement system 22. The control system 24 receives information from the measurement system 22 and controls the stage assemblies 18, 20 to precisely position the reticle 26 and the wafer 28. The control system 24 can include one or more processors and circuits.

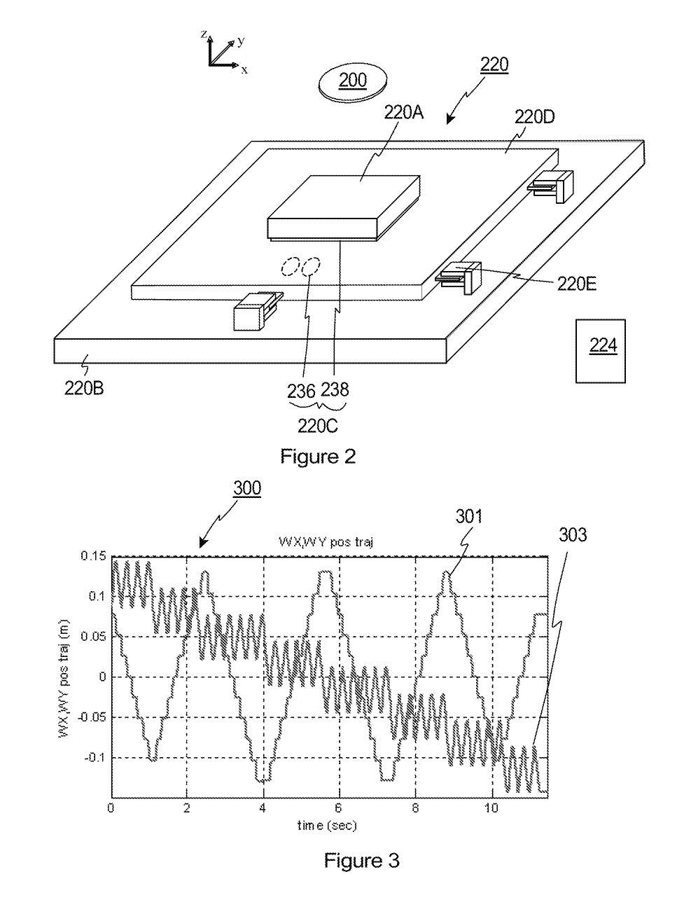

FIG. 2 is a simplified schematic illustration of a control system 224, and a stage assembly 220 that positions a work piece 200 (illustrated above the stage assembly 220) with improved accuracy and improved efficiency. In one embodiment, the work piece 200 can be the wafer 28 (illustrated in FIG. 1), and the stage assembly 220 can be used as the wafer stage assembly 22. Alternatively, the stage assembly 220 can be used to move and position other types of work pieces 200 (e.g. the reticle 26 illustrated in FIG. 1) during manufacturing and/or inspection.

In FIG. 2, the stage assembly 220 includes a stage 220A, a stage base 220B, a stage mover assembly 220C, and a countermass reaction assembly 220D. The design of these components can be varied to suit the requirements of the stage assembly 220. The stage 220A selectively retains the work piece 200. For example, the stage 220A can include a chuck for selectively retaining the work piece 200. The stage base 220B supports a portion of the stage mover assembly 220C. In FIG. 2, the stage 220A is a rigid, generally rectangular shaped plate, and the stage base 220B is also a rigid, generally rectangular shaped plate.

The stage mover assembly 220C moves the stage 220A and the work piece 200 relative to the stage base 220B and the reaction assembly 220D. In FIG. 2, the stage mover assembly 220C is designed to move the stage 220A with six degrees of freedom, namely along the X axis, along the Y axis, along the Z axis, about the X axis (theta X (Tx)), about the Y axis (theta Y (Ty)), and about the Z axis (theta Z (Tz)). Alternatively, the stage mover assembly 220C can be designed to move the stage 220A with fewer than six degrees of freedom.

In the non-exclusive embodiment illustrated in FIG. 2, the stage mover assembly 220C is a planar motor that includes a coil assembly 236 (partly illustrated in phantom) that is fixed to and moves with the reaction assembly 220D, and a magnet assembly 238 that is fixed to and moves with the stage 220A that cooperate to define a planar motor. With this design, the control system 224 can precisely control the current to the coil assembly 236 to position and move the stage 220A with six degrees of freedom. Additionally or alternatively, for example, the stage mover assembly 220C can include one or more linear actuators, voice coil motors, attraction-only actuators, or other types of actuators. In yet another alternative embodiment, the stage mover assembly 220C can be designed so that the coil assembly 236 is fixed to and moves with the stage 220A, and the magnet assembly 238 is secured to and moves with the reaction assembly 220D. Still alternatively or additionally, the stage mover assembly can include one or more linear motors, voice coil motors, rotary motors, or another type of actuator.

The stage 220A is maintained above the reaction assembly 220D with a stage bearing (not shown) that allows for motion of the stage 220A relative to the reaction assembly 220D along the X axis, along the Y axis and about the Z axis. For example, the stage bearing can be a magnetic type bearing (e.g. by levitation with the stage mover 220C), a vacuum preload air bearing, or a roller bearing type assembly.

Somewhat similarly, the reaction assembly 220D is maintained above the stage base 220B with a reaction bearing (not shown), e.g. a vacuum preload type fluid bearing. In this embodiment, the reaction bearing allows for motion of the reaction assembly 220D relative to the stage base 220B along the X axis, along the Y axis and about the Z axis relative to the stage base 220B. Alternately, for example, the reaction bearing 220E can be a magnetic type bearing, or a roller bearing type assembly.

The reaction assembly 220D counteracts, reduces, and minimizes the influence of the reaction forces from the stage mover 220C on the position of the stage base 220B. As provided above, the reaction component 236 of the stage mover 220C is coupled to the reaction assembly 220D. With this design, the reaction forces generated by the stage mover 220C are transferred to the reaction assembly 220D.

In FIG. 2, the reaction assembly 220D is a rectangular shaped countermass. Through the principle of conservation of momentum, (i) movement of the stage 220A with the stage mover 220C along the X axis in a first X direction along the X axis, generates an equal but opposite X reaction force that moves the countermass reaction assembly 220D in a second X direction that is opposite the first X direction along the X axis; (ii) movement of the stage 220A with the stage mover 220C along the Y axis in a first Y direction, generates an equal but opposite Y reaction force that moves the countermass reaction assembly 220D in a second Y direction that is opposite the first Y direction along the Y axis; and (iii) movement of the stage 220A with the stage mover 220C about the Z axis in a first theta Z direction, generates an equal but opposite theta Z reaction force (torque) that moves the countermass reaction assembly 220D in a second theta Z direction that is opposite the first theta Z direction about the Z axis.

Additionally, a trim mover 220E can be used to adjust the position of the reaction assembly 220D relative to the stage base 220A. For example, the trim mover 220E can include one or more rotary motors, voice coil motors, linear motors, electromagnetic actuators, or other type of actuators.

The control system 224 receives information from the measurement system 22 (illustrated in FIG. 1) and controls the stage mover assembly 220 to precisely position the work piece 200. The control system 224 includes one or more processors and circuits for performing the functions described herein.

As provided herein, the control system 224 directs electrical current to one or more of the conductors in the coil assembly 236. The electrical current through the conductors causes the conductors to interact with the magnetic field of the magnet assembly 238. This generates a force between the magnet assembly 238 and the coil assembly 236 that can be used to control, move, and position the stage 220A relative to the stage base 220B.

Typically, during the exposure process, numerous integrated circuits are formed on each wafer 28 (illustrated in FIG. 1). During this process, the reticle 26 (illustrated in FIG. 1) is commonly moved for a substantial number of repetitive, identical or substantially similar movements by the reticle stage assembly 18 (illustrated in FIG. 1). Similarly, during the exposure process, the wafer 28 is commonly moved for a substantial number of repetitive, identical or substantially similar movements by the wafer stage assembly 20 (illustrated in FIG. 1). Each such repetitive movement can also be referred to herein as an iteration, iterative movement, trajectory, cycle, first movement, or second movement.

FIG. 3 is a simplified graph that illustrates an X and Y trajectory of a stage during a non-exclusive example of a trajectory 300. More specifically, FIG. 3 includes (i) a line 301 that represents the X axis (WX) position of the stage versus time for the trajectory 300; and (ii) a line 303 that represents the Y axis (WY) position of the stage versus time for the trajectory 300. It should be noted that the entire trajectory 300 can be considered a movement, or a portion of the trajectory 300 can be considered a first movement, while another portion of the trajectory can be considered a second movement, and another portion of the trajectory can be considered a third movement, etc. In FIG. 3, the trajectory 300 can be an exposure sequence for an entire wafer or a portion thereof. It should be noted that stage can be moved in other trajectories that are the same, similar, or quite different than the trajectory 300 illustrated in FIG. 3. Stated in another fashion, this trajectory 300 is merely, a non-exclusive example of a possible trajectory for discussion, and that the present invention can be used for any other desired, possible trajectory.

It should also be noted that during the non-exclusive trajectory 300 illustrated in FIG. 3, that the stage is moved in a plurality of substantially similar X axis motions, and a plurality of substantially similar Y axis motions. These substantially similar X and Y axis motions can be repeated many times as part of this trajectory 300 or another trajectory.

Referring back to FIG. 2, the control system 224 controls the stage mover assembly 220C during each iteration. Further, as provided herein, the control system 224 collects iteration information during one or more of the iterations, and the control system 224 uses this information to control the stage mover assembly 220C during subsequent iterations to improve the positioning performance of the stage mover assembly 220C.

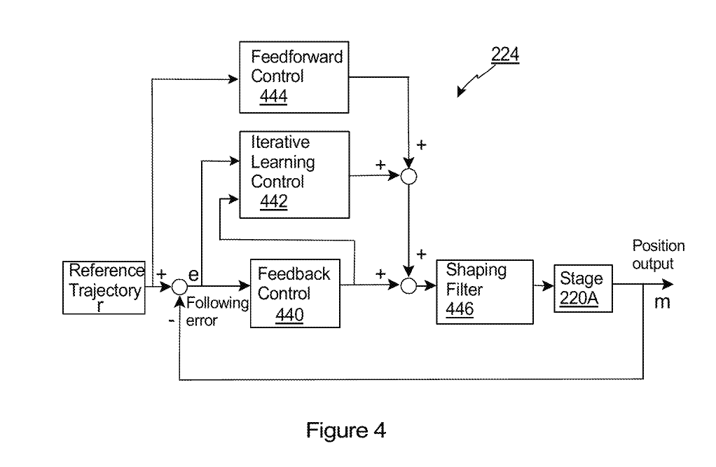

FIG. 4 is a simplified control block diagram of the control system 224 that can be used to control the stage mover assembly 220C (illustrated in FIG. 2) or another type of actuator. In FIG. 4, (i) “r” represents a desired reference trajectory, e.g. the desired trajectory (along the X, Y, and Z axes, and about the X, Y, and Z axes) of the stage 220A (illustrated in FIG. 2) or the work piece 200 (illustrated in FIG. 2) at a particular moment in time; (ii) “m” represents the measured, actual momentary, position output (along the X, Y, and Z axes, and about the X, Y, and Z axes) of the stage 220A or the work piece 200 as measured by the measurement system 22 (illustrated in FIG. 1) at a particular moment in time; and (iii) “e” represents a following error (along the X, Y, and Z axes, and about the X, Y, and Z axes), e.g. the error between the desired trajectory “r” and the measured output position “m” of the work piece 200 at a particular moment in time. For example, the following error can occur due to lack of complete rigidity in the components of the exposure apparatus, and/or a slight time delay between current being directed to the mover assembly and subsequent movement of the stage.

In FIG. 4, starting at the left side of the control block diagram, the desired trajectory “r” is fed into the control system 224 along with the measured position “m”. Next, the control system 224 determines the following error “e”.

Subsequently, the following error “e” is fed into a feedback control 440 of the control system 224. The feedback control 440 determines the force commands for the stage mover assembly 220C (illustrated in FIG. 2) along and about the X, Y and/or Z axes that are necessary to correct the following error (e.g. the forces necessary to move a center of gravity (“CG”), more precisely, the exposure position of wafer or reticle of the stage 220A to the desired trajectory “r”). The feedback control 440 may be in the form of a PID (proportional integral derivative) controller, proportional gain controller or a lead-lag filter, or other commonly known law in the art of control, for example.

In FIG. 4, the control system 224 includes an iterative learning control (“ILC”) 442 that collects information from previous iterations, and utilizes the iterative information from previous iterations to reduce the following error in subsequent iterations of the stage mover assembly 220C. In the embodiment illustrated in FIG. 4, the feedback force commands from the feedback control 440 and the following error are input into the iterative learning control 442. As non-exclusive examples, the iteration information collected by the iterative learning control 442 can include force data, current data, positioning data, positioning error data. For example, the positioning data can include “time-dependent” positioning data or “position dependent” positioning data. Time-dependent positioning data includes any information relating to the intended and/or actual position of the stage at various times. For instance, an example of time-dependent positioning data includes information regarding a following error of the stage, e.g. the difference between the intended position and the actual position of the stage at various times. Position-dependent positioning data includes information regarding the position of other components of the exposure apparatus that can influence position of the stage. Examples of position-dependent positioning data can include information regarding vibration of the optical assembly 16 (illustrated in FIG. 1) and/or the apparatus frame 12 (illustrated in FIG. 1).

As provided herein, the iterative learning control 442 processes this iteration information and utilizes this iteration information to control future movement of the stage. This allows for the improvement of the control of the stage mover assembly 220C in subsequent iterations. More specifically, as provided herein, an trajectory 300 (illustrated in FIG. 3) can be repeated many times during the processing of the work piece 200 (e.g. a reticle or a wafer). With iterative learning control 442, the iterative (“movement”) information from one or more of the previous iterations 300 is processed and utilized by the iterative learning control 442 to controlling future similar iterations 300. More specifically, the iterative learning control 442 uses the iterative information from previous iterations to improve the tracking accuracy from repetition to repetition by learning the required force commands need to move the stage 220A on the desired trajectory. Stated in another fashion, the iterative learning control 442 uses the iteration information from previous iterations to learn the required force commands for subsequent iterations. With this design, the control system 224 can achieve approximately perfect tracking because the iterative learning control 442 is able to learn the feedback force commands necessary to move the stage on subsequent, iterations.

As provided herein, the iterative learning control 442 is said to converge when a converged force command of the iterative learning control 442 provides approximately perfect force commands to compensate for the force command error of feedforward control 444 in the current iteration.

During the ILC learning, the iterative information is used to adjust the ILC force command until it converges. Typically, during the ILC learning process, the parameters of feedback control and feedforward remain unchanged. At any time, the control force may come from three portions, namely, the feedforward control, the ILC control, and the feedback control (as illustrated in FIG. 4).

It should be noted that iterative learning control 442 is position dependent. Thus, new information is performed for each new and different iteration or portion thereof. As provided herein, iterative learning control 442 is a data-based feedback control method. It takes some non-ignorable time to learn for every specific trajectory, which increases overhead time for process. In certain embodiments, the present invention provides a method to reduce the time for the iterative learning control 442 to converge for subsequent trajectories.

Additionally, in FIG. 4, the control system 224 includes a feedforward control 444. In certain embodiments, the feedforward control 444 is used to reduce the transient delay in the movement of the stage 220A. During movement of the stage 220A, the desired trajectory of the stage 220A and the mass of the stage 220A (and work piece) are known. The feedforward control 444 is used to inject a force needed to move the stage 220A towards its desired destination. This reduces the transient delay of the system.

As provided herein, the present invention uses information (e.g. can be provided by the ILC) from one or more previous movements to improve the feedforward control. More specifically, in one embodiment, the feedforward control 444 uses iterative information, such as the converged force command from a previous movement learned by the iterative learning control 442 to improve the commands from feedforward control 444A. As a result thereof, the initial trajectory in each subsequent movement will be more accurate (e.g. have a smaller following error). Because of the smaller initial following error, fewer subsequent iterations will be needed for the iterative learning control 442 to converge on the perfect force commands necessary to move the stage 220A. Stated in another fashion, for each unique trajectory (movement), it takes time (e.g. multiple iterative movements) for the iterative learning control 442 to converge and precisely determine the correct forces to be directed to the stage 220A. With a smaller initial following error, the tuning time for the converging on the perfect forces for that unique trajectory is reduced.

As provided herein, the feedforward control 444 generally works equally well for every different trajectory and is not position dependent. Generally, it takes some time and effort to optimize the parametric feedforward control, either by manual tuning or by auto-tuning methods. However, with the present invention, converged force command from the iterative learning control 442 can be utilized to optimize the parameters of a parametric feedforward control, without any extra tuning time. This feature leads to a very accurate parametric feedforward control 444, without the requirement of tuning or optimization process.

The resulting accurate feedforward control 444 subsequently allows the control system 224 to achieve a better baseline performance before iterative learning control 442. Subsequently, the required learning time for the iterative learning control 442 for each subsequent trajectory can be highly reduced.

It should be noted that in the embodiment illustrated in FIG. 4, that the reference trajectory (including one or more future trajectories) is input into the feedforward control 444. The feedforward control 444 can use the reference trajectory to generate feedforward force commands.

As illustrated in FIG. 4, the force commands from the feedback control 440, the iterative learning control 442, and the feedforward control 444 are fed into a shaping filter 446 that will used to determine the currents that are directed to conductors of the stage mover assembly 220C. For example, the shaping filter 446 can include a notch filter.

Next, at the stage block 220A, the current is directed to the mover assembly and this causes the stage 220A to move.

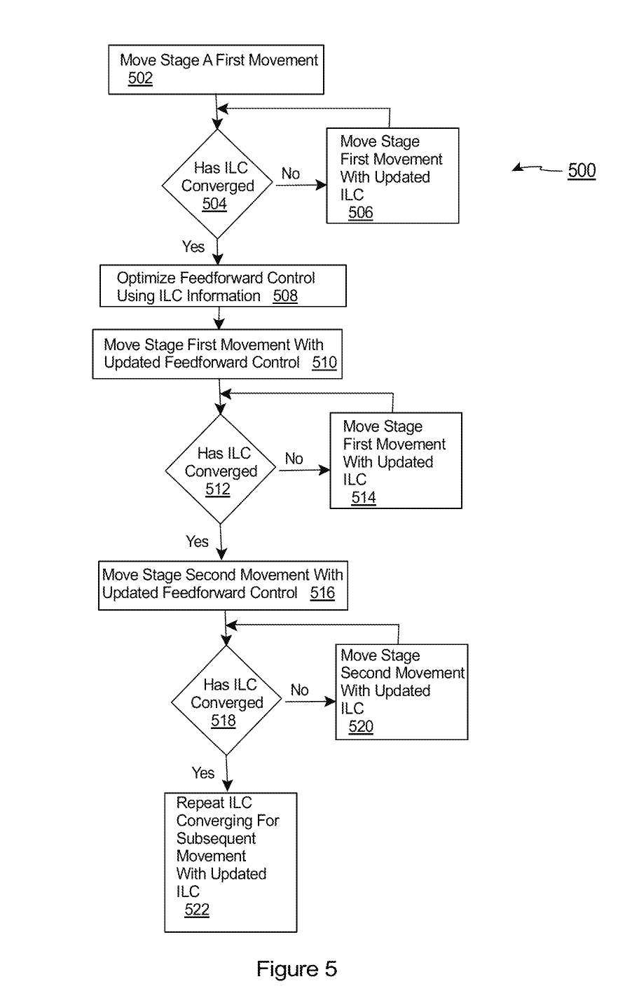

FIG. 5 is a simplified flow chart 500 that illustrates one, non-exclusive example of how the feedforward control can be optimized and the performance of control system can be optimized for multiple more trajectories. At step 502, the control system controls the stage mover assembly to move the stage and work piece through a first movement (e.g. an iteration) using the feedforward control and the feedback control. At this time, the feedforward control can be set at a default position. Further, the work piece moved by the stage can be a dummy work piece during initial tuning of the control system.

During the first movement, movement information from the first movement is provided to the iterative learning control. Next, at step 504, the control system determines if the iterative learning control has converged. If not, at step 506, the movement of the stage through the first movement is repeated using the updated iterative learning control. Next, at step 504, the control system determines if the iterative learning control has converged. It should be noted that steps 506 and 504 are repeated until the iterative learning control has converged. Achieving perfect tracking through iterations is represented by the mathematical requirement of convergence of the input signals. In certain embodiments, because the feedforward control is not optimized at this time, it can take anywhere from approximately four to six iterations for the iterative learning control to converge for the first movement.

Subsequently, after the iterative learning control has converged for the first movement, at step 508, the parametric feedforward control can be adjusted and optimized using the converged force command (“iterative information”) determined with the iterative learning control during the convergence for the first movement. Stated in another fashion, after the iterative learning control has converged for the first movement, the converged force command of the converged iterative learning control for the first movement can be used to optimize the parametric feedforward control used for future movements of the stage.

After the feedforward control has been optimized, the iterative learning control again needs to be converged for the first movement and other movements using the updated feedforward control. Stated in another fashion, after updating the feedforward control parameters, the iterative learning control has to be relearned for the first movement to reflect the required residual compensation force. It should be noted that because the parametric feedforward control has been optimized, the stage is positioned more accurately with a reduced following error. This will allow the iterative learning control to converge on the prefect force commands more quickly because the original following error for each movement is smaller.

Next, at step 510, the control system controls the stage mover assembly to again move the stage and work piece through the first movement using the updated feedforward control and the feedback control. During the first movement, movement information from the first movement is provided to the iterative learning control. Next, at step 512, the control system determines if the iterative learning control has converged. If not, at step 514, the first movement of the stage is repeated using the updated iterative learning control. Next, at step 512, the control system again determines if the iterative learning control has converged. It should be noted that steps 514 and 512 are repeated until the iterative learning control has again converged for the first movement. It should be noted that because the feedforward control has been optimized, the stage is positioned more accurately with a relatively small following error. Typically, this will allow the iterative learning control to converge on the prefect force commands for the first movement very quickly (e.g. one or two iterations).

In certain embodiments, the learned ILC force commands (converged force commands) for one or more individual movements are saved in memory (such as disk driver, RAM, etc.). Later, when the same movement needs be executed, the corresponding ILC force command will be retrieved from memory without the need of re-learning the converged force command for that particular movement.

As provided herein, another benefit of optimized feedforward control is to improve the stage accuracy for the movements (other than wafer exposure) that are not learned by the iterative learning control.

Subsequently, at step 516, the control system controls the stage mover assembly to again move the stage and work piece through a second movement that is different from the first movement using the updated feedforward control and the feedback control. During the second movement, movement information from the second movement is provided to the iterative learning control. Next, at step 518, the control system determines if the iterative learning control has converged. If not, at step 520, the first movement of the stage is repeated using the updated iterative learning control. Next, at step 518, the control system again determines if the iterative learning control has converged. It should be noted that steps 520 and 518 are repeated until the iterative learning control has converged for the second movement. It should be noted that because the feedforward control has been optimized, the stage is positioned more accurately with a relatively small following error for the initial second movement. Typically, this will allow the iterative learning control to converge on the prefect force commands for the second movement very quickly (e.g. one or two iterations).

Next, at step 520, the control system can sequentially control the stage mover assembly to again move the stage and work piece through each subsequent movement that is different from the previous movements using the updated feedforward control and the feedback control. During each subsequent movement, movement information from that movement is provided to the iterative learning control. Next, the iterative learning control can be sequentially converged for each subsequent movement. Importantly, because the feedforward control has been optimized, the stage is positioned more accurately with a relatively small following error for each subsequent movement. Typically, this will allow the iterative learning control to converge on the prefect force commands for each subsequent movement very quickly (e.g. one or two iterations). Thus, the present invention provides a method to improve the rate of this convergence (reduce the learning process of the iterative learning control) for subsequent movements.

Stated in another fashion, for each unique trajectory (movement), it takes time (e.g. multiple iterative movements) for the iterative learning control 442 to converge and precisely determine the correct forces to be directed to the stage 220A. With a smaller initial following error, the tuning time for the converging on the perfect forces for that unique trajectory is reduced. Thus, as provided herein, the problem of long learning time for the iterative learning control 442 at every individual movement thereof is solved by an accurate parametric feedforward control that has been optimized with the perfect force information provided by the iterative learning control 442 from another movement. Stated in another fashion, the problem of long settling time for stage motions other than exposure sequences is solved by an accurate parametric feedforward control, whose parameters are fitted with the perfect force information provided by the iterative learning control 442 for an exposure sequence.

Importantly, improvement of the co-operating parametric feedforward control may significantly improve the baseline system performance without iterative learning control 442 and thus reduces the learning time of the iterative learning control 442 for each new trajectory.

It should be noted that in the above, non-exclusive example, the parametric feedforward control that is optimized with the iterative information from the first movement is subsequently used for the control of the other movements. Alternatively, with the teachings provided herein, the parametric feedforward control can be individually optimized for some of or all of the subsequent trajectories.

Equation 1 below is one, non-exclusive example of how the feedforward control for the X axis and Y axis trajectory motion can be converted to six axis force commands, including X, Y, Z, theta X (“pitch”), theta Y (“roll”), and theta Z (“yaw”), to compensate for the cross-coupling dynamics from X Y motions to all six degrees of freedom:

$$( \begin{matrix}{u}_{ff , x} ( k ) \\ {u}_{ff , y} ( k ) \\ {u}_{ff , z} ( k ) \\ {u}_{ff , p} ( k ) \\ {u}_{ff , r} ( k ) \\ {u}_{ff , t} ( k )\end{matrix} ) = \underbrace{( \begin{matrix}{k}_{x} \cdot {\ddot{x}}_{r} ( k + {k}_{ahead} ) \\ {k}_{y} \cdot {\ddot{y}}_{r} ( k + {k}_{ahead} ) \\ 0 \\ 0 \\ 0 \\ 0\end{matrix} )}_{default feedforward control} + {\underbrace{( \begin{matrix}{k}_{xs}^{x} & {k}_{xj}^{x} & {k}_{xa}^{x} & {k}_{ys}^{x} & {k}_{yj}^{x} & {k}_{ya}^{x} \\ {k}_{xs}^{y} & {k}_{xj}^{y} & {k}_{xa}^{y} & {k}_{ys}^{y} & {k}_{yj}^{y} & {k}_{ya}^{y} \\ {k}_{xs}^{z} & {k}_{xj}^{z} & {k}_{xa}^{z} & {k}_{ys}^{z} & {k}_{yj}^{z} & {k}_{ya}^{z} \\ {k}_{xs}^{p} & {k}_{xj}^{p} & {k}_{xa}^{p} & {k}_{ys}^{p} & {k}_{yj}^{p} & {k}_{ya}^{p} \\ {k}_{xs}^{r} & {k}_{xj}^{r} & {k}_{xa}^{r} & {k}_{ys}^{r} & {k}_{yj}^{r} & {k}_{ya}^{r} \\ {k}_{xs}^{t} & {k}_{xj}^{t} & {k}_{xa}^{t} & {k}_{ys}^{t} & {k}_{yj}^{t} & {k}_{ya}^{t}\end{matrix} ) \cdot ( \begin{matrix}{x}_{r}^{( 4 )} ( k + {k}_{ahead} ) \\ {{x}^{…}}_{r} ( k + {k}_{ahead} ) \\ {\ddot{x}}_{r} ( k + {k}_{ahead} ) \\ {y}_{r}^{( 4 )} ( k + {k}_{ahead} ) \\ {{y}^{…}}_{r} ( k + {k}_{ahead} ) \\ {\ddot{y}}_{r} ( k + {k}_{ahead} )\end{matrix} )}}_{supplementary feedforward control} \underbrace{+ ( \begin{matrix}{k}_{xs , 1}^{x} & {k}_{xj , 1}^{x} & {k}_{xa , 1}^{x} & {k}_{ys , 1}^{x} & {k}_{yj , 1}^{x} & {k}_{ya , 1}^{x} \\ {k}_{xs , 1}^{y} & {k}_{xj , 1}^{y} & {k}_{xa , 1}^{y} & {k}_{ys , 1}^{y} & {k}_{yj , 1}^{y} & {k}_{ya , 1}^{y} \\ {k}_{xs , 1}^{z} & {k}_{xj , 1}^{z} & {k}_{xa , 1}^{z} & {k}_{ys , 1}^{z} & {k}_{yj , 1}^{z} & {k}_{ya , 1}^{z} \\ {k}_{xs , 1}^{p} & {k}_{xj , 1}^{p} & {k}_{xa , 1}^{p} & {k}_{ys , 1}^{p} & {k}_{yj , 1}^{p} & {k}_{ya , 1}^{p} \\ {k}_{xs , 1}^{r} & {k}_{xj , 1}^{r} & {k}_{xa , 1}^{r} & {k}_{ys , 1}^{r} & {k}_{yj , 1}^{r} & {k}_{ya , 1}^{r} \\ {k}_{xs , 1}^{t} & {k}_{xj , 1}^{t} & {k}_{xa , 1}^{t} & {k}_{ys , 1}^{t} & {k}_{yj , 1}^{t} & {k}_{ya , 1}^{t}\end{matrix} ) \cdot ( \begin{matrix}{x}_{r}^{( 4 )} ( k + {k}_{ahead} + 1 ) \\ {{x}^{…}}_{r} ( k + {k}_{ahead} + 1 ) \\ {\ddot{x}}_{r} ( k + {k}_{ahead} + 1 ) \\ {y}_{r}^{( 4 )} ( k + {k}_{ahead} + 1 ) \\ {{y}^{…}}_{r} ( k + {k}_{ahead} + 1 ) \\ {\ddot{y}}_{r} ( k + {k}_{ahead} + 1 )\end{matrix} )}_{supplementary feedforward control} \qquad Equation 1$$

In the equations provided herein, (i) u_{ff,x} is the X axis, feedforward control force command; (ii) u_{ff,y} is the Y axis, feedforward control force command; (iii) u_{ff,z} is the Z axis, feedforward control force command; (iv) u_{ff,p}, is the theta X (“pitch”) feedforward control force command; (v) u_{ff,r}, is the theta Y (“roll”) feedforward control force command; (vi) u_{ff,t}: is the theta Z (‘yaw”) feedforward control force command; (vii) \ddot{x}ᵣ is the X axis acceleration reference trajectory; (viii) [symbol] is the X-axis jerk reference trajectory; (ix) xᵣ⁽⁴⁾ is the X-axis snap reference trajectory; (ix) ÿᵣ is the Y axis acceleration reference trajectory; (x) [symbol] is the Y-axis jerk reference trajectory; (xi) yᵣ⁽⁴⁾ is the Y-axis snap reference trajectory; (xii) kₓ is the default acceleration feedforward control parameter in the X axis; (xiii) k_{y} is the default acceleration feedforward control parameter in the Y axis; (xiv) k is time stamp of digital control; (xv) k_{ahead} is the samples ahead for feedforward control to accommodate system time delay; and (xvi) k_{ahead+1} is the one more sample ahead than k_{ahead}.

Further, in these equations (i) x represents the X axis, (ii) y represents the Y axis, (iii) z represents the Z axis, (iv) p represents pitch (theta X), (v) r represents roll (theta Y), and (vi) t represents yaw (theta Z).

In Equation 1, the feedforward control is for the two, relatively large stage motions, e.g. the X axis and the Y axis. Alternatively, the feedforward control can include more than two degrees of freedom.

The feedforward control in Equation 1 consists of two portions: namely (1) the default feedforward control, which is roughly tuned for X and Y single-axis motion; and (2) supplementary feedforward control, which addresses the stage higher-order dynamics and cross-coupling issues.

From Equation 1, the elements in the following matrix represents the default feedforward control:

$$\underbrace{( \begin{matrix}{k}_{x} \cdot {\ddot{x}}_{r} ( k + {k}_{ahead} ) \\ {k}_{y} \cdot {\ddot{y}}_{r} ( k + {k}_{ahead} ) \\ 0 \\ 0 \\ 0 \\ 0\end{matrix} )} \qquad Equation 2$$

Further, from Equation 1, the elements in the following matrix represents the time-ahead reference trajectories used in the feedforward control:

$$\underbrace{( \begin{matrix}{x}_{r}^{( 4 )} ( k + {k}_{ahead} ) \\ {{x}^{…}}_{r} ( k + {k}_{ahead} ) \\ {\ddot{x}}_{r} ( k + {k}_{ahead} ) \\ {y}_{r}^{( 4 )} ( k + {k}_{ahead} ) \\ {{y}^{…}}_{r} ( k + {k}_{ahead} ) \\ {\ddot{y}}_{r} ( k + {k}_{ahead} )\end{matrix} )} \qquad Equation 3$$

Moreover, from Equation 1, the elements in the following matrix represents the reference trajectories of one more time ahead than Equation 3, that allows for the feedforward control to accommodate the system delay that is not an integer multiple of the sample period:

$$\underbrace{( \begin{matrix}{x}_{r}^{( 4 )} ( k + {k}_{ahead} + 1 ) \\ {{x}^{…}}_{r} ( k + {k}_{ahead} + 1 ) \\ {\ddot{x}}_{r} ( k + {k}_{ahead} + 1 ) \\ {y}_{r}^{( 4 )} ( k + {k}_{ahead} + 1 ) \\ {{y}^{…}}_{r} ( k + {k}_{ahead} + 1 ) \\ {\ddot{y}}_{r} ( k + {k}_{ahead} + 1 )\end{matrix} )} \qquad Equation 4$$

In Equation 1, (i) the default feedforward control (equation 2), (ii) the time-ahead trajectories (equation 3), and (iii) time-ahead trajectories, one more sample ahead (equation 4) are known. However, from Equation 1, the parameter matrices of supplementary feedforward control, in the following matrices are unknown and can be solved using the force command of the converged iterative learning control:

$$\begin{matrix}( \begin{matrix}{k}_{xs}^{x} & {k}_{xj}^{x} & {k}_{xa}^{x} & {k}_{ys}^{x} & {k}_{yj}^{x} & {k}_{ya}^{x} \\ {k}_{xs}^{y} & {k}_{xj}^{y} & {k}_{xa}^{y} & {k}_{ys}^{y} & {k}_{yj}^{y} & {k}_{ya}^{y} \\ {k}_{xs}^{z} & {k}_{xj}^{z} & {k}_{xa}^{z} & {k}_{ys}^{z} & {k}_{yj}^{z} & {k}_{ya}^{z} \\ {k}_{xs}^{p} & {k}_{xj}^{p} & {k}_{xa}^{p} & {k}_{ys}^{p} & {k}_{yj}^{p} & {k}_{ya}^{p} \\ {k}_{xs}^{r} & {k}_{xj}^{r} & {k}_{xa}^{r} & {k}_{ys}^{r} & {k}_{yj}^{r} & {k}_{ya}^{r} \\ {k}_{xs}^{t} & {k}_{xj}^{t} & {k}_{xa}^{t} & {k}_{ys}^{t} & {k}_{yj}^{t} & {k}_{ya}^{t}\end{matrix} ) and & Equation 5 \\ ( \begin{matrix}{k}_{xs , 1}^{x} & {k}_{xj , 1}^{x} & {k}_{xa , 1}^{x} & {k}_{ys , 1}^{x} & {k}_{yj , 1}^{x} & {k}_{ya , 1}^{x} \\ {k}_{xs , 1}^{y} & {k}_{xj , 1}^{y} & {k}_{xa , 1}^{y} & {k}_{ys , 1}^{y} & {k}_{yj , 1}^{y} & {k}_{ya , 1}^{y} \\ {k}_{xs , 1}^{z} & {k}_{xj , 1}^{z} & {k}_{xa , 1}^{z} & {k}_{ys , 1}^{z} & {k}_{yj , 1}^{z} & {k}_{ya , 1}^{z} \\ {k}_{xs , 1}^{p} & {k}_{xj , 1}^{p} & {k}_{xa , 1}^{p} & {k}_{ys , 1}^{p} & {k}_{yj , 1}^{p} & {k}_{ya , 1}^{p} \\ {k}_{xs , 1}^{r} & {k}_{xj , 1}^{r} & {k}_{xa , 1}^{r} & {k}_{ys , 1}^{r} & {k}_{yj , 1}^{r} & {k}_{ya , 1}^{r} \\ {k}_{xs , 1}^{t} & {k}_{xj , 1}^{t} & {k}_{xa , 1}^{t} & {k}_{ys , 1}^{t} & {k}_{yj , 1}^{t} & {k}_{ya , 1}^{t}\end{matrix} ) & Equation 6\end{matrix}$$

Stated in another fashion, the supplementary feedforward control in Equations 5 and 6 can be determined (fine-tuned) using the converged force command of the converged iterative learning control. For example, in certain embodiments, the supplementary feedforward control can be determined by curve fitting the following Equation 7 below with a least squares method, using the ILC force command (learned with only the default feedforward control) and stage X and Y trajectories.

More specifically, Equation 7 below is one, non-exclusive example of how the iterative learning control for the six degrees of freedom can be converted to six axis supplementary feedforward force commands, including X, Y, Z, theta X (“pitch”), theta Y (“roll”), and theta Z (“yaw”).

$$( \begin{matrix}{u}_{ILC , x} ( k ) \\ {u}_{ILC , y} ( k ) \\ {u}_{ILC , z} ( k ) \\ {u}_{ILC , p} ( k ) \\ {u}_{ILC , r} ( k ) \\ {u}_{ILC , t} ( k )\end{matrix} ) = \underbrace{( \begin{matrix}{k}_{xs}^{x} & {k}_{xj}^{x} & {k}_{xa}^{x} & {k}_{ys}^{x} & {k}_{yj}^{x} & {k}_{ya}^{x} \\ {k}_{xs}^{y} & {k}_{xj}^{y} & {k}_{xa}^{y} & {k}_{ys}^{y} & {k}_{yj}^{y} & {k}_{ya}^{y} \\ {k}_{xs}^{z} & {k}_{xj}^{z} & {k}_{xa}^{z} & {k}_{ys}^{z} & {k}_{yj}^{z} & {k}_{ya}^{z} \\ {k}_{xs}^{p} & {k}_{xj}^{p} & {k}_{xa}^{p} & {k}_{ys}^{p} & {k}_{yj}^{p} & {k}_{ya}^{p} \\ {k}_{xs}^{r} & {k}_{xj}^{r} & {k}_{xa}^{r} & {k}_{ys}^{r} & {k}_{yj}^{r} & {k}_{ya}^{r} \\ {k}_{xs}^{t} & {k}_{xj}^{t} & {k}_{xa}^{t} & {k}_{ys}^{t} & {k}_{yj}^{t} & {k}_{ya}^{t}\end{matrix} ) \cdot ( \begin{matrix}{x}_{r}^{( 4 )} ( k + {k}_{ahead} ) \\ {{x}^{…}}_{r} ( k + {k}_{ahead} ) \\ {\ddot{x}}_{r} ( k + {k}_{ahead} ) \\ {y}_{r}^{( 4 )} ( k + {k}_{ahead} ) \\ {{y}^{…}}_{r} ( k + {k}_{ahead} ) \\ {\ddot{y}}_{r} ( k + {k}_{ahead} )\end{matrix} )}_{supplementary feedforwarded control} \underbrace{+ ( \begin{matrix}{k}_{xs , 1}^{x} & {k}_{xj , 1}^{x} & {k}_{xa , 1}^{x} & {k}_{ys , 1}^{x} & {k}_{yj , 1}^{x} & {k}_{ya , 1}^{x} \\ {k}_{xs , 1}^{y} & {k}_{xj , 1}^{y} & {k}_{xa , 1}^{y} & {k}_{ys , 1}^{y} & {k}_{yj , 1}^{y} & {k}_{ya , 1}^{y} \\ {k}_{xs , 1}^{z} & {k}_{xj , 1}^{z} & {k}_{xa , 1}^{z} & {k}_{ys , 1}^{z} & {k}_{yj , 1}^{z} & {k}_{ya , 1}^{z} \\ {k}_{xs , 1}^{p} & {k}_{xj , 1}^{p} & {k}_{xa , 1}^{p} & {k}_{ys , 1}^{p} & {k}_{yj , 1}^{p} & {k}_{ya , 1}^{p} \\ {k}_{xs , 1}^{r} & {k}_{xj , 1}^{r} & {k}_{xa , 1}^{r} & {k}_{ys , 1}^{r} & {k}_{yj , 1}^{r} & {k}_{ya , 1}^{r} \\ {k}_{xs , 1}^{t} & {k}_{xj , 1}^{t} & {k}_{xa , 1}^{t} & {k}_{ys , 1}^{t} & {k}_{yj , 1}^{t} & {k}_{ya , 1}^{t}\end{matrix} ) \cdot ( \begin{matrix}{x}_{r}^{( 4 )} ( k + {k}_{ahead} + 1 ) \\ {{x}^{…}}_{r} ( k + {k}_{ahead} + 1 ) \\ {\ddot{x}}_{r} ( k + {k}_{ahead} + 1 ) \\ {y}_{r}^{( 4 )} ( k + {k}_{ahead} + 1 ) \\ {{y}^{…}}_{r} ( k + {k}_{ahead} + 1 ) \\ {\ddot{y}}_{r} ( k + {k}_{ahead} + 1 )\end{matrix} )}_{supplementary feedforward control} \qquad Equation 7$$

In the equations provided herein, (i) u_{ILC,x} is the X axis, ILC control (iii) force command; (ii) u_{ILC,y} is the Y axis, ILC control force command; (iii) u_{ILC,z} is the Z axis, ILC control force command; (iv) u_{ILC,p} is the theta X (“pitch”) ILC control force command; (v) u_{ILC,r} is the theta Y (“roll”) ILC control force command; (vi) u_{ILC,t} is the theta Z (‘yaw”) ILC control force command.

From Equation 7, the six ILC force commands below are learned from the iterative learning process (e.g. after convergence of a first movement) utilizing the default feedforward control:

$$( \begin{matrix}{u}_{ILC , x} ( k ) \\ {u}_{ILC , y} ( k ) \\ {u}_{ILC , z} ( k ) \\ {u}_{ILC , p} ( k ) \\ {u}_{ILC , r} ( k ) \\ {u}_{ILC , t} ( k )\end{matrix} ) ⏟ \qquad Equation 8$$

Further, from Equation 7, the trajectory information below is also known (similar to Equations 3 and 4):

$$\begin{matrix}\underbrace{( \begin{matrix}{x}_{r}^{( 4 )} ( k + {k}_{ahead} ) \\ {{x}^{…}}_{r} ( k + {k}_{ahead} ) \\ {\ddot{x}}_{r} ( k + {k}_{ahead} ) \\ {y}_{r}^{( 4 )} ( k + {k}_{ahead} ) \\ {{y}^{…}}_{r} ( k + {k}_{ahead} ) \\ {\ddot{y}}_{r} ( k + {k}_{ahead} )\end{matrix} )} & Equation 9 \\ \underbrace{( \begin{matrix}{x}_{r}^{( 4 )} ( k + {k}_{ahead} + 1 ) \\ {{x}^{…}}_{r} ( k + {k}_{ahead} + 1 ) \\ {\ddot{x}}_{r} ( k + {k}_{ahead} + 1 ) \\ {y}_{r}^{( 4 )} ( k + {k}_{ahead} + 1 ) \\ {{y}^{…}}_{r} ( k + {k}_{ahead} + 1 ) \\ {\ddot{y}}_{r} ( k + {k}_{ahead} + 1 )\end{matrix} )} & Equation 10\end{matrix}$$

In this example, Equation 7 can be solved to determine the parameter matrices of supplementary feedforward control:

$$\begin{matrix}( \begin{matrix}{k}_{xs}^{x} & {k}_{xj}^{x} & {k}_{xa}^{x} & {k}_{ys}^{x} & {k}_{yj}^{x} & {k}_{ya}^{x} \\ {k}_{xs}^{y} & {k}_{xj}^{y} & {k}_{xa}^{y} & {k}_{ys}^{y} & {k}_{yj}^{y} & {k}_{ya}^{y} \\ {k}_{xs}^{z} & {k}_{xj}^{z} & {k}_{xa}^{z} & {k}_{ys}^{z} & {k}_{yj}^{z} & {k}_{ya}^{z} \\ {k}_{xs}^{p} & {k}_{xj}^{p} & {k}_{xa}^{p} & {k}_{ys}^{p} & {k}_{yj}^{p} & {k}_{ya}^{p} \\ {k}_{xs}^{r} & {k}_{xj}^{r} & {k}_{xa}^{r} & {k}_{ys}^{r} & {k}_{yj}^{r} & {k}_{ya}^{r} \\ {k}_{xs}^{t} & {k}_{xj}^{t} & {k}_{xa}^{t} & {k}_{ys}^{t} & {k}_{yj}^{t} & {k}_{ya}^{t}\end{matrix} ) and & Equation 11 \\ ( \begin{matrix}{k}_{xs , 1}^{x} & {k}_{xj , 1}^{x} & {k}_{xa , 1}^{x} & {k}_{ys , 1}^{x} & {k}_{yj , 1}^{x} & {k}_{ya , 1}^{x} \\ {k}_{xs , 1}^{y} & {k}_{xj , 1}^{y} & {k}_{xa , 1}^{y} & {k}_{ys , 1}^{y} & {k}_{yj , 1}^{y} & {k}_{ya , 1}^{y} \\ {k}_{xs , 1}^{z} & {k}_{xj , 1}^{z} & {k}_{xa , 1}^{z} & {k}_{ys , 1}^{z} & {k}_{yj , 1}^{z} & {k}_{ya , 1}^{z} \\ {k}_{xs , 1}^{p} & {k}_{xj , 1}^{p} & {k}_{xa , 1}^{p} & {k}_{ys , 1}^{p} & {k}_{yj , 1}^{p} & {k}_{ya , 1}^{p} \\ {k}_{xs , 1}^{r} & {k}_{xj , 1}^{r} & {k}_{xa , 1}^{r} & {k}_{ys , 1}^{r} & {k}_{yj , 1}^{r} & {k}_{ya , 1}^{r} \\ {k}_{xs , 1}^{t} & {k}_{xj , 1}^{t} & {k}_{xa , 1}^{t} & {k}_{ys , 1}^{t} & {k}_{yj , 1}^{t} & {k}_{ya , 1}^{t}\end{matrix} ) & Equation 12\end{matrix}$$

It should be noted that (i) the matrix of Equation 11 is the same as the matrix of Equation 5, and (ii) the matrix of Equation 12 is the same as the matrix of Equation 6. Thus, Equation 7 can be solved to determine the matrices of Equation 11 (and Equation 5), and Equation 12 (and Equation 6). Subsequently, supplemental feedforward control information in Equations 5 and 6 can be used in Equation 1 to determine the optimized parametric feedforward control commands.

With this design, the supplementary feedforward control parameter matrices in Equations 5 and 6 can be determined using the converged force command of the iterative learning control. As provided herein, the supplementary feedforward control in Equations 11 and 12 can be determined by curve fitting Equation 7 below with a least squares method, using the converged force command of the ILC (learned with only the default feedforward control) and stage X and Y trajectories. Stated in another fashion, the supplementary feedforward control parameter matrices can be determined using Equation 7. These supplemental feedforward control parameter matrices can then be utilized in Equation 1 to optimize the feedforward control.

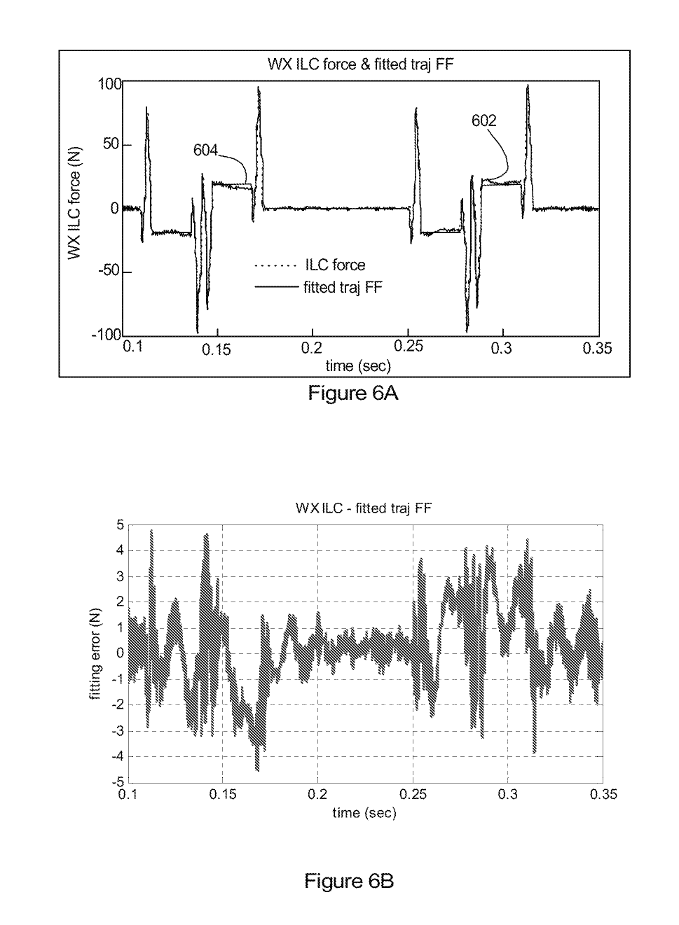

FIG. 6A is a graph that illustrates X axis, iterative learning control (“ILC”) force and curve fitted, X axis supplemental feedforward (“FF”) control versus time for a small portion of the trajectory motion in FIG. 3. More specifically, FIG. 6A includes (i) line 602 that represents the X axis, ILC force (determined through the convergence after multiple iterations) necessary to properly position the stage versus time (without the optimized feedforward control), and (ii) line 604 that represents the subsequently determined, X axis, supplemental feedforward control that was determined by curve fitting of the X axis, ILC force. For general X Y trajectory motions, the X axis, optimized feedforward control Equation (1) including the supplemental feedforward control is used instead of the X axis, ILC force illustrated in FIG. 6A. It should be noted that in FIG. 6A, before application of the optimized feedforward control, the required X axis ILC force was relatively large (e.g. approximately one hundred Newtons at certain times).

FIG. 6B is a graph that illustrates the new X axis ILC force versus time required to properly position the stage along the X axis for a small portion of the trajectory when the X axis supplemental feedforward control of FIG. 6A is utilized. FIG. 6B illustrates that the new X axis ILC force is relatively small (less than five Newtons). This means that the fitting error between the X axis, ILC force and the curve fitted, X axis supplemental feedforward (“FF”) control from FIG. 6A is relatively small. This also means that the optimized parametric feedforward control is relatively accurate for the X axis, and the baseline system performance for the X axis is relatively good even without iterative learning control. As a result thereof, the X axis learning time of the iterative learning control is relatively small.

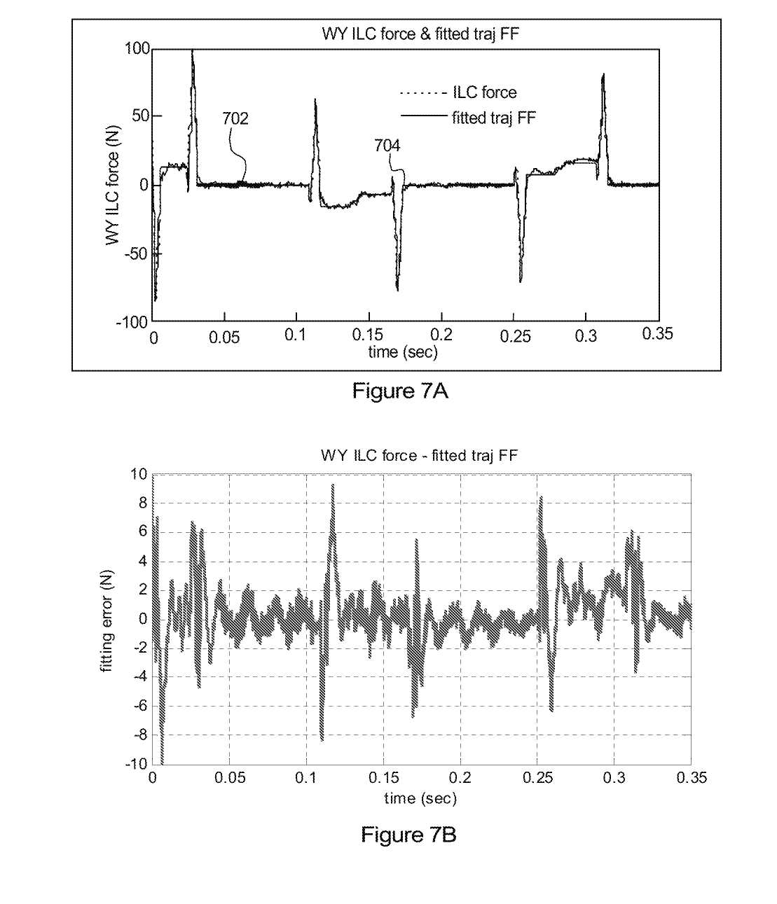

FIG. 7A is a graph that illustrates Y axis, ILC force and curve fitted, Y axis supplemental feedforward control versus time for a small portion of the trajectory. FIG. 7A includes (i) line 702 that represents the Y axis, ILC force (determined through the convergence after multiple iterations) necessary to properly position the stage versus time (without the optimized feedforward control), and (ii) line 704 that represents the subsequently determined, Y axis, supplemental feedforward control determined by curve fitting of the Y axis, ILC force. For general stage X Y trajectory motions, the Y axis, supplemental feedforward control is used instead of the Y axis, ILC force illustrated in FIG. 7A. It should be noted that in FIG. 7A, without the optimized feedforward control, the required Y axis ILC force was relatively large (e.g. one hundred Newtons at certain times).

FIG. 7B is a graph that illustrates the new the Y axis ILC force versus time required to properly position the stage along the Y axis for a small portion of the trajectory when the Y axis supplemental feedforward control of FIG. 7A is utilized. FIG. 7B illustrates that the new Y axis ILC force is relatively small (less than ten Newtons). This means that the fitting error between the Y axis, ILC force and the curve fitted, Y axis supplemental feedforward (“FF”) control from FIG. 7A is relatively small. This also means that the optimized parametric feedforward control is relatively accurate for the Y axis, and the baseline system performance for the Y axis is relatively good even without iterative learning control. As a result thereof, the Y axis learning time of the iterative learning control is relatively small.

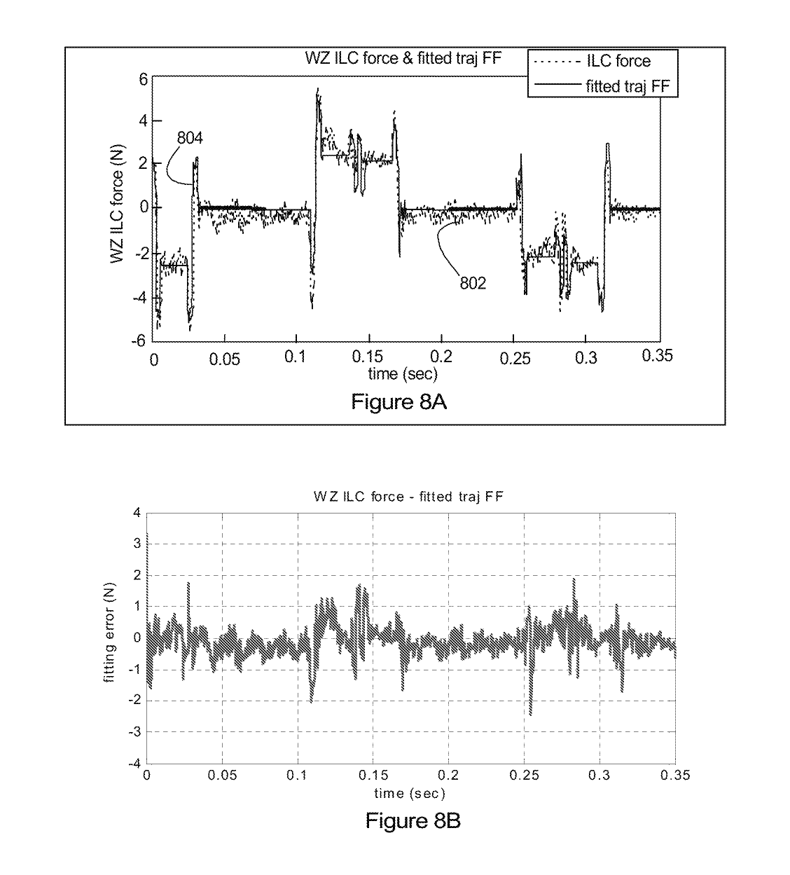

FIG. 8A is a graph that illustrates Z axis, ILC force and curve fitted, Z axis supplemental feedforward control versus time for a small portion of the trajectory. FIG. 8A includes (i) line 802 that represents the Z axis, ILC force (determined through the convergence after multiple iterations) necessary to properly position the stage versus time (without the optimized feedforward control), and (ii) line 804 that represents the subsequently determined, Z axis, supplemental feedforward control determined by curve fitting of the Z axis, ILC force. For general X Y trajectory motions, the Z axis, supplemental feedforward control is used instead of the Z axis, ILC force illustrated in FIG. 8A. It should be noted that in FIG. 8A, without the optimized feedforward control, the required Z axis ILC force can be relatively large (e.g. 5.5 Newtons at certain times).

FIG. 8B is a graph that illustrates the new the Z axis ILC force versus time required to properly position the stage along the Z axis for a small portion of the trajectory when the Z axis supplemental feedforward control of FIG. 8A is utilized. FIG. 8B illustrates that the new Z axis ILC force is relatively small (less than two Newtons). This means that the fitting error between the Z axis, ILC force and the curve fitted, Z axis supplemental feedforward (“FF”) control from FIG. 8A is relatively small. This also means that the optimized parametric feedforward control is relatively accurate for the Z axis, and the baseline system performance for the Z axis is relatively good even without iterative learning control. As a result thereof, the Z axis learning time of the iterative learning control is relatively small.

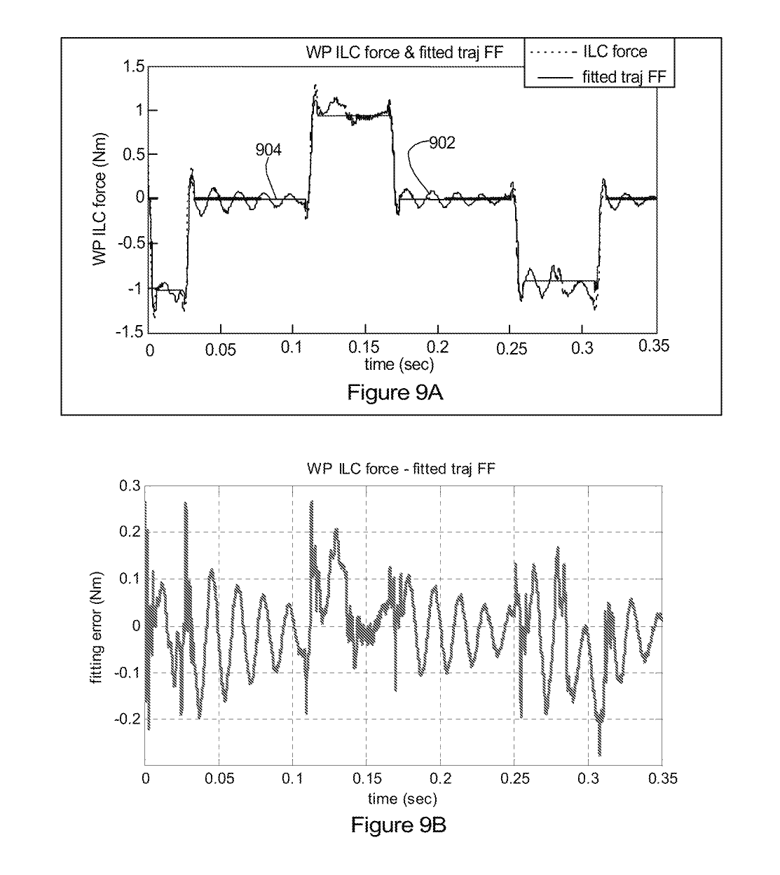

FIG. 9A is a graph that illustrates theta-X, ILC force and curve fitted, theta-X supplemental feedforward control versus time for a small portion of the trajectory. FIG. 9A includes (i) line 902 that represents the theta-X, ILC force (determined through the convergence after multiple iterations) necessary to properly position the stage versus time (without the optimized feedforward control), and (ii) line 904 that represents the subsequently determined, theta-X, supplemental feedforward control determined by curve fitting of the theta-X, ILC force. For general X Y trajectory motions, the theta-X, supplemental feedforward control is used instead of the theta-X, ILC force illustrated in FIG. 9A. It should be noted that in FIG. 9A, without the optimized feedforward control, the required theta-X axis ILC force can be relatively large (e.g. 1.3 Newtons at certain times).

FIG. 9B is a graph that illustrates the new the theta-X ILC force versus time required to properly position the stage about the X axis for a small portion of the trajectory when the theta-X supplemental feedforward control of FIG. 9A is utilized. FIG. 9B illustrates that the new theta-X ILC force is relatively small (less than 0.3 Newtons). This means that the fitting error between the theta-X, ILC force and the curve fitted, theta-X supplemental feedforward (“FF”) control from FIG. 9A is relatively small. This also means that the optimized parametric feedforward control is relatively accurate for theta-X, and the baseline system performance is relatively good even without iterative learning control. As a result thereof, the theta-X learning time of the iterative learning control is relatively small.

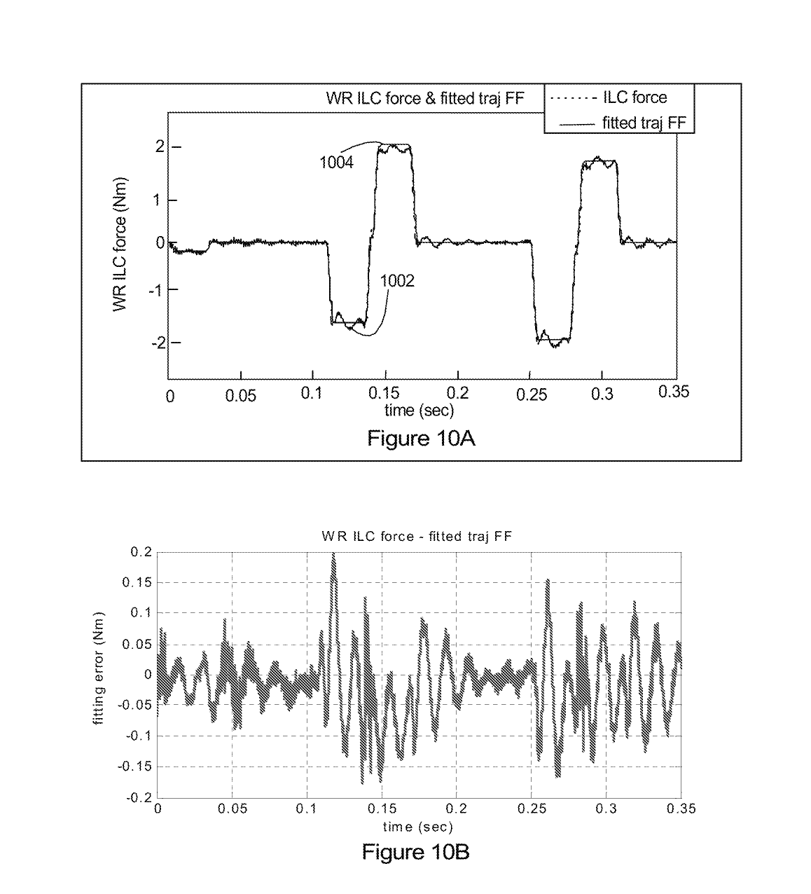

FIG. 10A is a graph that illustrates theta-Y, ILC force and curve fitted, theta-Y supplemental feedforward control versus time for a small portion of the iteration. FIG. 10A includes (i) line 1002 that represents the theta-Y, ILC force (determined through the convergence after multiple iterations) necessary to properly position the stage versus time (without the optimized feedforward control), and (ii) line 1004 that represents the subsequently determined, theta-Y axis, supplemental feedforward control determined by curve fitting of the theta-Y, ILC force. For general X Y trajectory motions, the theta-Y, supplemental feedforward control is used instead of the theta-Y, ILC force illustrated in FIG. 10A. It should be noted that in FIG. 10A, without the optimized feedforward control, the required theta-Y axis ILC force can be relatively large (e.g. 1.9 Newtons at certain times).

FIG. 10B is a graph that illustrates the new the theta-Y ILC force versus time required to properly position the stage about the Y axis for a small portion of the trajectory when the theta-Y supplemental feedforward control of FIG. 10A is utilized. FIG. 10B illustrates that the new theta-Y ILC force is relatively small (less than 0.2 Newtons). This means that the fitting error between the theta-Y, ILC force and the curve fitted, theta-Y supplemental feedforward (“FF”) control from FIG. 10A is relatively small. This also means that the optimized parametric feedforward control is relatively accurate, and the baseline system performance for movements about the Y axis is relatively good even without iterative learning control. As a result thereof, the theta-Y learning time of the iterative learning control is relatively small.

Additionally, the improved feedforward control provided herein can also improve the system performance for movements that do not use the iterative learning control, such as those for alignments, sensor calibrations and wafer/reticle loading and unloading, etc.

It is to be understood that embodiments disclosed herein are merely illustrative of the some embodiments of the invention and that no limitations are intended to the details of construction or design herein shown other than as described in the appended claims.

What is claimed is:

1. A method for controlling a mover assembly that moves a stage, the method comprising the steps of:
(i) providing a control system that controls the mover assembly, the control system including a feedforward control, a feedback control, and an iterative learning control;
(ii) moving the stage through a first movement with the mover assembly being controlled with the control system;
(iii) collecting first movement information relating to the first movement of the stage with the iterative learning control;
(iv) adjusting the iterative learning control using the first movement information;
(v) repeating steps (ii) through (iv) until the iterative learning control converges for the first movement; and
(vi) adjusting the feedforward control using a converged force command of the iterative learning control.

2. The method of claim 1 wherein the step of adjusting the feedforward control includes the step of using the converged force command of Iterative learning control to optimize the feedforward control.

3. The method of claim 1 further comprising the steps of (a) moving the stage through the first movement with the mover assembly being controlled with the control system utilizing the adjusted feedforward control; (b) collecting first movement information relating to the first movement of the stage with the iterative learning control; (c) adjusting the iterative learning control using the first movement information; and (d) repeating steps (a) through (c) until the iterative learning control converges for the first movement.

4. The method of claim 3 further comprising the steps of (A) moving the stage through a second movement that is different from the first movement with the mover assembly being controlled with the control system utilizing the adjusted feedforward control; (B) collecting second movement information relating to the second movement of the stage with the iterative learning control; (C) adjusting the iterative learning control for the second movement using the second movement information; and (D) repeating steps (A) through (C) until the iterative learning control converges for the second movement.

5. The method of claim 4 further comprising the steps of (I) moving the stage through a third movement that is different from the first and second movements with the mover assembly being controlled with the control system utilizing the adjusted feedforward control; (II) collecting third movement information relating to the third movement of the stage with the iterative learning control; (III) adjusting the iterative learning control for the third movement using the third movement information; and (IV) repeating steps (I) through (III) until the iterative learning control converges for the third movement.

6. The method of claim 1 further comprising the steps of (A) moving the stage through a second movement that is different from the first movement with the mover assembly being controlled with the control system utilizing the adjusted feedforward control; (B) collecting second movement information relating to the second movement of the stage with the iterative learning control; (C) adjusting the iterative learning control for the second movement using the second movement information; and (D) repeating steps (A) through (C) until the iterative learning control converges for the second movement.

7. A method for making an exposure apparatus for transferring an image to a work piece, the method comprising the steps of providing an optical assembly, securing the work piece to a stage, and moving the stage with the mover assembly of claim 1 relative to the optical assembly, and controlling the mover assembly with the method of claim 1.

8. A method for manufacturing a device comprising the steps of providing a substrate, and forming an image to the substrate with the exposure apparatus made by the method of claim 7.

9. A method for controlling a mover assembly that moves a stage, the method comprising the steps of:
(i) providing a control system that controls the mover assembly, the control system including a feedforward control, a feedback control, and an iterative learning control;
(ii) moving the stage through a first movement with the mover assembly being controlled with the control system;
(iii) collecting first movement information relating to the first movement of the stage with the iterative learning control; and
(iv) adjusting the feedforward control using iterative information from the iterative learning control.

10. The method of claim 9 wherein the step of adjusting the feedforward control includes the step of using the iterative information to optimize the feedforward control.

11. The method of claim 9 further comprising the steps of (a) moving the stage through the first movement with the mover assembly being controlled with the control system utilizing the adjusted feedforward control; (b) collecting first movement information relating to the first movement of the stage with the iterative learning control; (c) adjusting the iterative learning control using the first movement information.

12. The method of claim 11 further comprising the steps of (A) moving the stage through a second movement that is different from the first movement with the mover assembly being controlled with the control system utilizing the adjusted feedforward control; (B) collecting second movement information relating to the second movement of the stage with the iterative learning control; and (C) adjusting the iterative learning control for the second movement using the second movement information.

13. The method of claim 12 further comprising the steps of (I) moving the stage through a third movement that is different from the first and second movements with the mover assembly being controlled with the control system utilizing the adjusted feedforward control; (II) collecting third movement information relating to the third movement of the stage with the iterative learning control; and (III) adjusting the iterative learning control for the third movement using the third movement information.

14. The method of claim 9 further comprising the steps of (A) moving the stage through a second movement that is different from the first movement with the mover assembly being controlled with the control system utilizing the adjusted feedforward control; (B) collecting second movement information relating to the second movement of the stage with the iterative learning control; and (C) adjusting the iterative learning control for the second movement using the second movement information.

15. A method for making an exposure apparatus for transferring an image to a work piece, the method comprising the steps of providing an optical assembly, securing the work piece to a stage, and moving the stage with the mover assembly of claim 9 relative to the optical assembly, and controlling the mover assembly with the method of claim 9.

16. An assembly that moves a work piece, the assembly comprising:
a stage that retains the work piece;
a mover assembly that moves the stage and the work piece a first movement; and
a control system that controls the mover assembly, the control system including a feedforward control, a feedback control, and an iterative learning control; wherein the feedforward control is adjusted using iterative information from the iterative learning control that relates to the first movement.

17. The assembly of claim of claim 16 wherein the control system (i) controls the mover assembly to move the stage through the first movement with the mover assembly; (ii) collects first movement information relating to the first movement of the stage with the iterative learning control; (iii) adjusts the iterative learning control using the first movement information; and (iv) repeat (i) through (iii) until the iterative learning control converges for the first movement; and (v) adjusts the feedforward control using a converged force command from the iterative learning control.

18. The assembly of claim 16 wherein the feedforward control is adjusted to optimize the feedforward control.

19. The assembly of claim of claim 16 wherein the control system (a) controls the mover assembly to move the stage through a second movement with the mover assembly that is different from the first movement; (b) collects second movement information relating to the second movement of the stage with the iterative learning control; (c) adjusts the iterative learning control using the second movement information; and (d) repeat (a) through (c) until the iterative learning control converges for the second movement.

20. The assembly of claim of claim 19 wherein the control system (I) controls the mover assembly to move the stage through a third movement with the mover assembly that is different from the first and second movements; (II) collects third movement information relating to the third movement of the stage with the iterative learning control; (III) adjusts the iterative learning control using the third movement information; and (IV) repeat (I) through (III) until the iterative learning control converges for the third movement.

21. An exposure apparatus that creates an image on a work piece, the exposure apparatus including an optical assembly, and the assembly of claim 16 that moves the work piece relative to the optical assembly.

22. An exposure apparatus that transfers an image from the work piece to a wafer, the exposure apparatus including an optical assembly, and the assembly of claim 16 that moves the work piece relative to the optical assembly.
